(19) United States
(12) Patent Application Publication
(10) Pub. No.: US 2026/0037993 A1
(43) Pub. Date: Feb. 5, 2026

(54) DETERMINING INTERACTION CONTEXT FOR INTERACTIONS GENERATED FROM USER ENGAGEMENT EVENTS

(71) Applicant: Qualtrics, LLC, Provo, UT (US)

(72) Inventor: Ray Gerber, Inlet Beach, FL (US)

(21) Appl. No.: 18/793,112

(22) Filed: Aug. 2, 2024

(51) Int. Cl. G06Q 30/0201; H04L 67/306

(52) U.S. Cl. CPC G06Q 30/0201; H04L 67/306

(57) ABSTRACT

The present disclosure relates to systems, non-transitory computer-readable media, and methods for generating interaction contexts for interactions of user engagement events. In particular, in one or more embodiments, the disclosed systems receive engagement data corresponding to a user engagement event and utilize a large language model to generate interactions and interaction contexts from the engagement data. In addition, the disclosed systems can generate interactions and corresponding interaction contexts associated with a user profile for user engagement events across multiple engagement events. Moreover, the disclosed systems can utilize the interaction contexts to update a user profile of an experience management system or associate the interaction to an experience journey associated with the user profile.

### BACKGROUND

Recent years have seen significant improvements in identifying and extracting information from user interactions. For example, conventional systems can identify or track an experience journey based on receiving user interactions corresponding to various touchpoints for an experience journey and deliver personalized content or perform actions at various stages along the experience journey. In addition, conventional systems can analyze data corresponding to user feedback and identify a sentiment for the user feedback. To illustrate, conventional systems identify a sentiment, such as positive, neutral, or negative, for unstructured text from user feedback. However, there are a number of technical deficiencies with regard to identifying the circumstances or settings surrounding extracting information from user feedback.

For example, though conventional systems can identify a sentiment for some user interactions, conventional systems are inaccurate as they fail to account for the circumstances or settings surrounding user feedback. Specifically, while conventional systems can parse a salient portion from unstructured text (e.g., transcripts, comments, survey answers) and identify a sentiment, conventional systems fail to account for the context surrounding the user interaction. To illustrate, conventional systems can identify various user interactions, such as website views, emails, or call transcripts, and identify whether the sentiment was positive or negative for the interactions based on receiving a user sentiment indication on a website or analyzing unstructured text of email or call transcripts. However, conventional systems fail to identify where an interaction falls in a customer journey. Thus, while conventional systems can identify a sentiment was positive or negative, they fail to identify whether the interaction is negative at the start, middle, or end of a customer journey, along with intents or motivations for the sentiment. Indeed, conventional systems may identify a user interaction and a sentiment for the user interaction but completely fail to identify additional interactions and factors that contribute to reasoning and motivations behind the user interaction and/or the sentiment.

In part due to their inaccuracy in failing to identify factors, intents, and motivations of user interactions, conventional systems are also inflexible because they can identify sentiment only from a single interaction. For example, conventional systems can provide a summary of an interaction with a corresponding sentiment or can parse text into salient portions and identify a sentiment for each portion. However, conventional systems are unable to account for related interactions occurring throughout different engagement types or across multiple types of media. To illustrate, not only do conventional systems only identify a sentiment from a user interaction with a certain interface (e.g., text from a phone call, an email, a survey response), but they fail to identify other interactions (e.g., website views, social media comments) that contribute to sentiment.

Also, in part due to their inaccuracy, conventional systems are also inefficient. Because conventional systems fail to identify factors, reasoning, and motivations behind user interactions and behaviors, conventional systems spend excess processing and computing power gathering preferences, data, or other information for a user profile. For example, conventional systems often generate content (e.g., surveys, emails, calls) in an attempt to identify user preferences. As another example, conventional systems often identify a negative sentiment with a user interaction and spend large amounts of processing and computing power to generate additional content in an effort to identify the reasoning behind the negative sentiment. These, along with additional problems and issues, exist with regard to conventional systems.

### BRIEF SUMMARY

Embodiments of the present disclosure provide benefits and/or solve one or more of the foregoing or other problems in the art with systems, non-transitory computer-readable media, and methods for determining interaction contexts for interactions generated from user engagement with various engagement interfaces. For example, in one or more embodiments, the disclosed systems receive data corresponding to a user engagement with touchpoints across various channels, then intelligently generate interactions from the data and determine an interaction context for each interaction. In addition, in one or more embodiments, the disclosed systems utilize the interaction context to update a user profile of an experience management system based on the interaction context. Moreover, in one or more embodiments, the disclosed systems utilize the interaction context to determine additional actions for an experience journey associated with the user profile. Additional features and advantages of one or more embodiments of the present disclosure are outlined in the description that follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a context determination system can operate in accordance with one or more embodiments.

FIG. 2 illustrates a schematic diagram of an example overview of a context determination system generating interactions from engagement data and determining interaction contexts for the interactions in accordance with one or more embodiments.

FIG. 3 illustrates a schematic diagram of a context determination system utilizing a large language model to generate an interaction and determine an interaction context from engagement data in accordance with one or more embodiments.

FIGS. 4A-4E illustrates an example of a context determination system generating interactions from, for example engagement data, determining interaction contexts, and associating the interaction context to experience journeys of a user profile in accordance with one or more embodiments.

FIG. 5 illustrates a schematic diagram of a context determination system receiving engagement data from multiple engagement interfaces and updating a user profile within an experience management system in accordance with one or more embodiments.

FIG. 6 illustrates a schematic diagram of a context determination system associating enrichment data to interactions in accordance with one or more embodiments.

FIG. 7 illustrates a flowchart of a series of acts for generating an interaction and determining an interaction context in accordance with one or more embodiments.

FIG. 8 illustrates a block diagram of an example computing device for implementing one or more embodiments of the present disclosure.

FIG. 9 illustrates a network of an experience management system in accordance with one or more embodiments.

### DETAILED DESCRIPTION

This disclosure describes one or more embodiments of a context determination system that identifies interactions from unstructured data and determines a context for each interaction. For example, the context determination system receives engagement data corresponding to a user engagement with various engagement touchpoints and generates one or more interactions from the engagement data. The context determination system then determines an interaction context for each interaction and extracts a user preference from the interaction context in order to update a user profile. Further, in one or more embodiments, the context determination system utilizes the interaction context to identify touchpoints of an experience journey associated with the user profile or to determine (and execute) system actions with respect to the user profile.

As mentioned, the context determination system receives engagement data corresponding to user engagement with various engagement touchpoints with engagement interfaces. In particular, the context determination system receives engagement data corresponding to user engagement events with engagement interfaces across various platforms and through various methods of engagement, such as communicating information, asking questions, or a user action. To illustrate, engagement data corresponding to a user engagement event can comprise viewer data from a web page, usage data from a client application, unstructured text data from an electronic communication, or unstructured text data from an audio communication.

As mentioned, in one or more embodiments, the context determination system generates an interaction from engagement data. Specifically, the context determination system generates (or identifies) a discrete portion of the engagement data that refers to an idea, focus, or salient portion from a larger exchange in a user engagement event. In some cases, the context determination system provides a prompt to a large language model to generate an interaction from engagement data. For example, the context determination system extracts content from the engagement data and analyzes the content to provide a contextual prompt to the large language model. In addition, in one or more embodiments, the context determination system analyzes the engagement data to identify a topic according to a topic model and provides the topic to the large language model with the contextual prompt to generate the interaction.

As also mentioned, in one or more embodiments, the context determination system determines an interaction context for each interaction. Specifically, the context determination determines an interaction context that indicates or denotes intent, motivations, or other factors that influence an interaction. For example, the context determination system utilizes a large language model to determine the interaction context for the interaction. In some cases, such as when the large language model is outside the experience management system, the context determination system protects secure data by associating enrichment data to an interaction after the large language model generates the interaction.

Further, as mentioned, in one or more embodiments, the context determination system utilizes the interaction context to update a user profile with an experience management system. In particular, the context determination system extracts a user preference from an interaction context and updates the user profile by applying the user preference to the user profile. For example, the context determination system extracts a user preference by identifying a user interest, a user motivation, a user intent, a user want, a user need, a user demographic, or user personalized content from the interaction context.

Moreover, as briefly mentioned, in one or more embodiments the context determination system utilizes the interaction context to identify touchpoints of an experience journey associated with the user profile. For example, the context determination system can determine, based on the interaction context, that an interaction corresponds to an initiation touchpoint for an experience journey and begin tracking an experience journey for the user profile. As another example, the context determination system can determine, based on the interaction context, that an interaction corresponds to an intermediate touchpoint of an experience journey associated with the user profile and associate the interaction with the experience journey. In some cases, the context determination system can also determine, based on the interaction context, a next journey touchpoint for an experience journey associated with the user profile. Moreover, the context determination system can determine and execute a system action corresponding to the next journey touchpoint.

The context determination system provides a variety of technical advantages relative to conventional systems. For example, by identifying interaction context, the context determination system improves accuracy relative to conventional systems. Specifically, unlike conventional systems that can merely identify salient portions of text and identify a sentiment within that portion of text, the context determination system can generate an interaction and corresponding interaction context. The context determination system utilizes a trained large language model that can accurately and quickly generate interactions that include an exchange of ideas, data, or communication and an interaction context that identifies the motivations, factors, and intents of the interaction. Further, the context determination system can utilize a large language model to generate the interaction and corresponding interaction context from a single large language prompt. Moreover, the context determination system can identify how a user interaction relates to an experience journey of a customer, such as where it starts, progresses, or ends an experience journey, and correlates the context to the experience journey. Indeed, because the context experience system can link user interactions and context to experience journeys, the context determination system is able to correlate user profile actions with the user reasoning behind the actions, which conventional systems fail to capture.

The context determination system also increases flexibility over conventional systems because not only does the context determination system identify interactions and interaction contexts, but the context determination system also identifies contexts and interactions from multiple user engagement interactions across multiple engagement interfaces. Specifically, unlike conventional systems that can simply identify a summary or sentiment of a single interaction, the context determination system can receive engagement data from user engagement events across multiple engagement interfaces (e.g., web pages, calls, emails, messaging apps, social media) and identify contexts and relationships between the interactions. For example, the context determination system utilizes interaction contexts to identify that multiple user engagement events that occur across multiple engagement interfaces are part of the same experience journey. As another example, based on interaction context, the context determination system identifies how webpages fit in with other user engagement events, such as customer service calls, emails, messaging application exchanges, or social media posts/comments.

Moreover, unlike conventional systems that expend excess and unnecessary processing power attempting to gather data and information from users about preferences or reasoning behind sentiments, the context determination system increases efficiency by extracting user preferences from interaction contexts. Specifically, the context determination system utilizes a large language model to generate an interaction context and extracts user preferences from the interaction contexts that indicate user interests, expected outcomes, and motivations. Indeed, the context determination system does not need to expend additional energy to create content to which a client device may or may not respond but instead extracts accurate user preferences from interactions associated with the user profile that are already recorded.

As illustrated by the foregoing discussion, the present disclosure utilizes a variety of terms to describe the features and advantages of the context determination system. Additional detail is now provided regarding the meaning of such terms. For example, as used herein, the term “user engagement event” refers to a user interaction with an interface about a service, product, or platform. In particular, the term “user engagement event” can include user interaction, involvement, or engagement with an interface that produces data about the interaction corresponding to a service, platform, product, or interaction. For example, a user engagement event can refer to a call, an email, social media posts or comments, a chat utilizing a messaging application, mobile application usage, or a web page view.

Also, as used herein, the term “engagement data” refers to data that represents a user interaction with an interface of a service, platform, product, or event. In particular, the term “engagement data” can include data that depicts or represents the substance of the user interaction, information related to the product or service with which the user interacted, or the words spoken or typed during the user interaction. To illustrate, engagement data can include, but is not limited to, a transcript from a phone call, text from an email or email exchange, social media text or data indications, messaging application interactions, data corresponding to web page views, or data generated from mobile application usage.

Additionally, as used herein, the term “engagement interface” refers to a point of interaction or communication where two entities interact. In particular, the term “engagement interface” refers to a device, system, application, and/or service that facilitates the exchange of information, resources, or data. For example, an engagement interface can be hardware-based, like a client device, or software-based, such as APIs or graphical user interfaces that allow interaction within software applications. To illustrate, an engagement interface includes a phone (e.g., a mobile phone or landline for making a phone call), a web browser, a messaging application, a mobile application, or an email system.

In addition, as used herein, the term “interaction” refers to a piece of exchange, discourse, or communication that comprises a discrete component of a larger exchange, discourse, or communication. In particular, the term “interaction” refers to a salient portion of an exchange between two entities that pertains to a specific subject, theme, issue, or matter. For example, an interaction can portray information, ideas, concerns, or discussion about products, services, or other offerings from a system, platform, or company. To illustrate, an interaction can comprise a discussion about a service for a certain car found within a larger discussion between a user and a customer service agent. As another illustration, an interaction can include a client device accessing a webpage through a web browser.

Moreover, as used herein, the term “interaction context” refers to the circumstances, conditions, or factors that surround and influence an interaction. In particular, “interaction context” refers to information, experiences, prior knowledge, or relationships that influence the nature of an exchange or communication of an interaction. To illustrate, interaction context can include interests, motivations, intents, wants, needs, demographics, or personalized content.

Further, as used herein, the term “user profile” refers to data associated with a user of an experience management system. In particular, “user profile” refers to a comprehensive set of data and demographic information representing an individual user’s characteristics, tendencies, desires, and historical interactions within the experience management system. To illustrate, the term “user profile” refers to dynamic and personalized data, such as past activities, inclinations for types of experiences, feedback on previous interactions, and behavioral patterns.

As used herein, the term “user preference” refers to specific likes, choices, or inclinations within a particular system or environment. In particular, “user preference” refers to data stored or associated with a user profile that indicates the likes, choices, or inclinations of a user with respect to products, features, services, customizations, or content. To illustrate, a user preference can include interests, motivations, intents, wants, needs, demographics, or personalized content. In some cases, a user preference is extracted from an interaction context.

In addition, as used herein, the term “topic” refers to a group of similar concepts or themes. In particular, “topic” refers to an object, subject, or idea that serves as the focus of an interaction. To illustrate, topics can vary widely, ranging from broad (or parent) subjects such as “staff attributes” that contain smaller (or child) subtopics, such as “staff attitude,” “staff efficiency,” or “staff knowledge.” Relatedly, the term “topic family” refers to a range of related topics that share common elements, subjects, or ideas. For example, a “topic family” can group together topics for a more organized and comprehensive understanding of an area of interest. To illustrate, the topic “staff attributes” can belong to a topic family of “human resource management.”

Further, as used herein, the term “topic model” refers to a database, document, or system for organizing and identifying topics. In particular, the term “topic model” refers to a database, document, or system that amalgamates different topics into a single understandable structure. In some cases, a topic model is a single layer. In other cases, a topic model has multiple layers or groupings and organizes topics in a hierarchical structure, such as with parent-child topic groupings or taxonomies.

Moreover, as used herein, the term “contextual prompt” refers to a cue or question designed to elicit a response or action that considers the specific circumstances or background relevant to the situation. In particular, the term “contextual prompt” refers to a prompt for a large language model that comprises or includes information that is specific to a certain interaction or event. For example, a contextual prompt can comprise a direction to identify an interaction and/or an interaction context and can comprise a topic or content associated with a user engagement event.

As used herein, the term “experience journey” refers to an organized set of activities experienced by at least one user during interactions with an entity. To illustrate, an experience journey can include an ordered set of conditions, events, and/or actions encountered, performed, and/or experienced by a user during a user experience with the products or services of a company, an organization, or another entity. Such conditions, events, and/or actions may be recorded or tracked by computing devices of an entity or the user.

In addition, as used herein, the term “touchpoint” refers to a measured point of interaction or contact. In particular, the term “touchpoint” refers to a condition, event, or action encountered as part of an experience journey of a user. Relatedly, the term “initiation touchpoint” refers to a condition, event, or action that initiates or starts an experience journey. The term “intermediate touchpoint” refers to a condition, event, or action encountered during an experience journey (e.g., does not begin an experience journey). The term “next journey touchpoint” refers to an estimated, anticipated, or likely condition, event, or action that will be encountered or performed by a user in response to or because of a previous touchpoint.

Additionally, as used herein, the term “system action” refers to a digital act, modification, process, task, or operation in relation to data corresponding to a particular system or platform. In particular, a system action can include a variety of actions, digital tasks, modifications, processes, or operations that modify, create, transmit, display, or store various data. In one or more embodiments, a system action includes implementing particular rules, data, and/or functions within a computing system. For example, a system action can include transmitting an electronic communication, generating a digital ticket, updating digital survey distribution data, adding data identifying or generating an orchestration trigger, adding or inserting code into a software application, or transmitting data to a third-party server, and a variety of other system actions. In certain implementations, a system action includes one or more bulk actions (e.g., large batches of actions performed over and over). For instance, a system action can include myriad different digital tasks across a variety of computing devices.

In addition, as used herein, the term “machine-learning model” refers to a computer algorithm or a collection of computer algorithms that automatically improve for a particular task through iterative outputs or predictions based on the use of data. For example, a machine-learning model can utilize one or more learning techniques to improve accuracy and/or effectiveness. Example machine-learning models include various types of neural networks, decision trees, support vector machines, linear regression models, and Bayesian networks. In addition, as used herein, the term “trained machine-learning model” refers to a machine-learning model that is local to a content management system. For example, the trained machine-learning model is hosted, located, stored, or executed within a content management system. Moreover, as used herein, the term “third-party machine-learning model” refers to a machine-learning model that is external to a content management system. For example, a third-party machine-learning model is hosted, located, stored, or executed outside of a content management system. Relatedly, as used herein, the term “designated machine-learning model” refers to a machine-learning model selected by a model selection machine-learning model to execute a task.

Relatedly, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., interactions and/or interaction contexts) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a machine-learning model.

In addition, as used herein, the term “large language model” refers to a machine-learning model trained to perform computer tasks to generate or identify interactions from unstructured text. In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., interaction outputs, interaction context outputs) based on prompts and/or to identify interactions based on various contextual data, including graph information from a knowledge graph and/or historical user account behavior. In some cases, a large language model comprises various commercially available models such as, but not limited to, GPT (e.g., GPT 3.5, GPT 4), ChatGPT, Llama (e.g., Llama2-7B, Llama 3), BERT, Claude, Cohere.

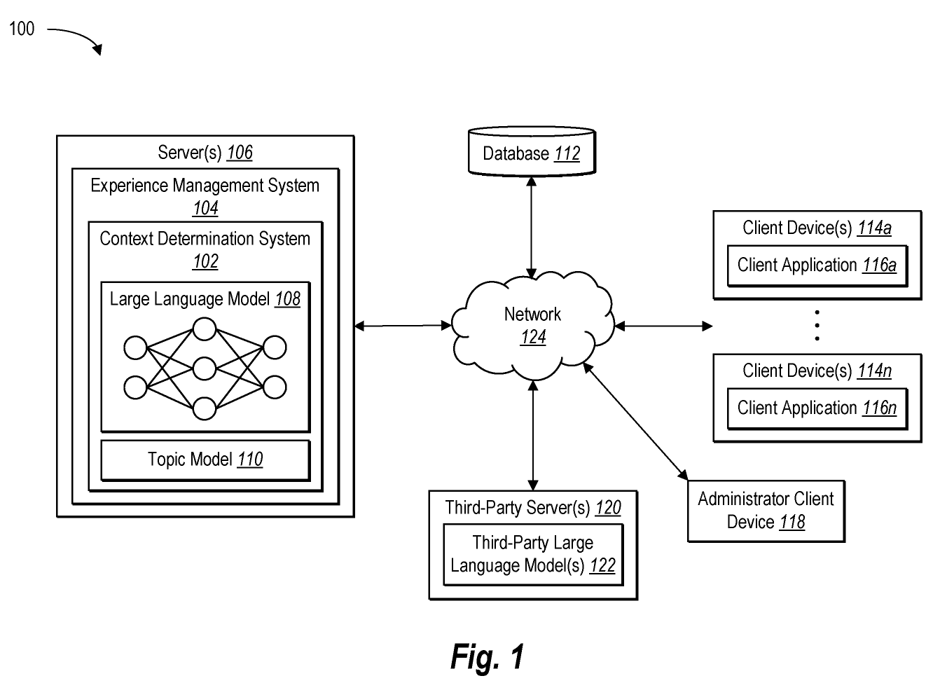

Additional details regarding the context determination system will now be provided with reference to the figures. For example, FIG. 1 illustrates a block diagram of a system environment for implementing a context determination system 102 in accordance with one or more embodiments. An overview of the context determination system 102 is described in relation to FIG. 1. Thereafter, a more detailed description of the components and processes of the context determination system 102 is provided in relation to the subsequent figures.

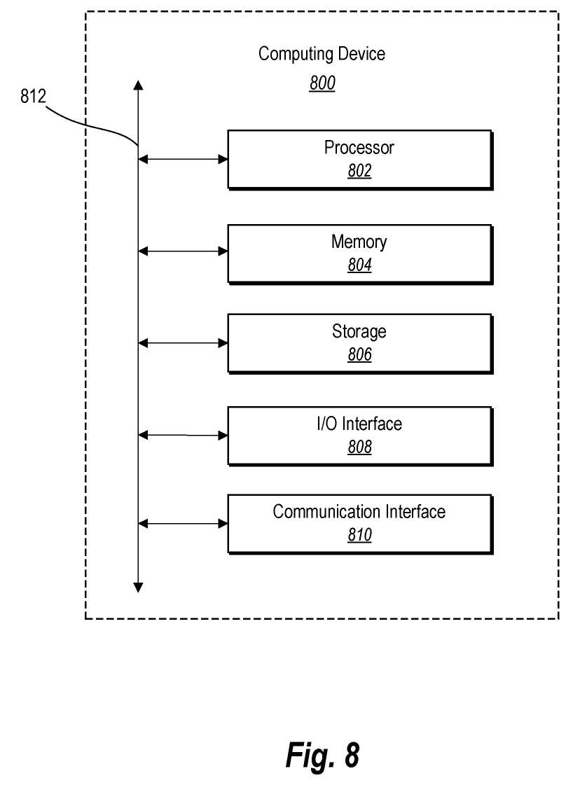

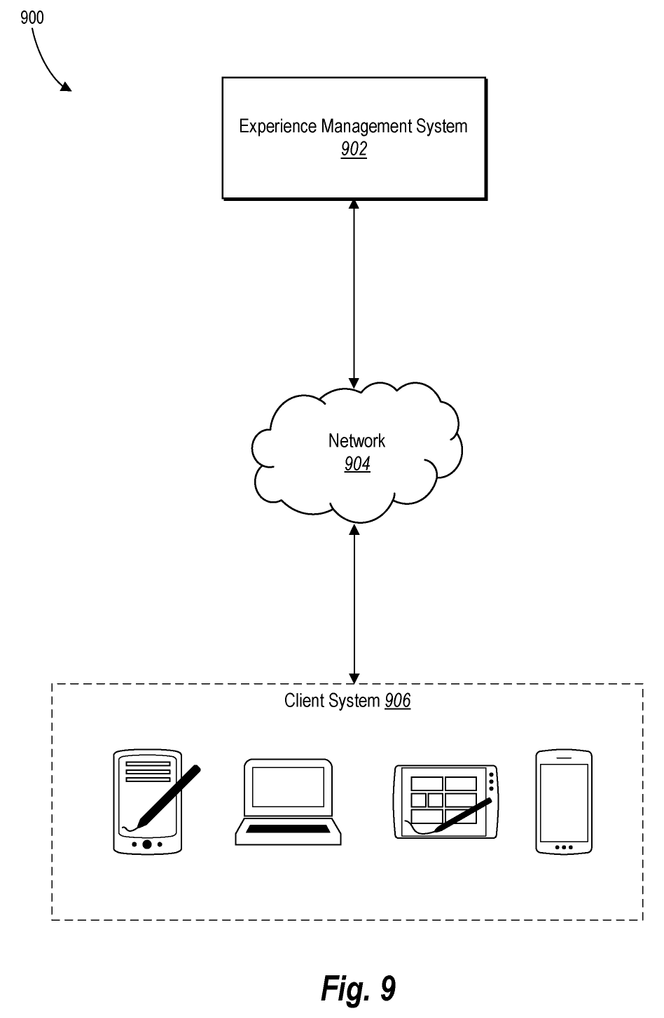

As shown, the environment 100 includes server(s) 106, database 112, client device(s) 114a-114n, administrator client device 118, and third-party server(s) 120. Each of the components of environment 100 can communicate via network 124, and network 124 can be any suitable network over which computing devices can communicate. Example networks are discussed in more detail below in relation to FIGS. 8-9.

As mentioned above, environment 100 includes client device(s) 114a-114n and an administrator client device 118. The administrator client device 118 may be associated with an administrator of the experience management system 104 and/or the context determination system 102. The client device(s) 114a-114n or the administrator client device 118 can be one of a variety of computing devices, including a smartphone, a tablet, a smart television, a desktop computer, a laptop computer, a virtual reality device, an augmented reality device, or another computing device as described in relation to FIGS. 8-9. The client device(s) 114a-114n and the administrator client device 118 can communicate with the server(s) 106 via network 124. For example, the client device(s) 114a-114n or the administrator client device 118 can receive user input from a user interacting with the client device(s) 114a-114n (e.g., via the client application 116a-116n) or the administrator client device 118 to, for instance, select interface elements to interact with an experience management system or to select options that initiate execution of a task. In addition, the context determination system 102 or the server(s) 106 can receive information relating to various interactions and/or user interface elements based on the input received by the client device(s) 114a-114n or the administrator client device 118.

As shown, the client device(s) 114a-114n can include a client application 116a-116n. In particular, the client application 116a-116n may be a web application, a native application installed on the client device(s) 114a-114n (e.g., a mobile application, a desktop application, etc.), or a cloud-based application where all or part of the functionality is performed by the server(s) 106. Based on instructions from the client application 116a-116n, the client device(s) 114a-114n can present or display information, including a user interface for interacting with (or collaborating regarding) initiating tasks. Using the client application, the client device(s) 114a-114n can perform (or request to perform) various operations, such as executing a task and/or inputting text comprising actions or prompts to generate a specific output. Though not shown, the administrator client device 118 can include a client application that allows for or provides specific functionality for an administrator of the experience management system 104 or the context determination system 102.

As illustrated in FIG. 1, the environment 100 also includes the server(s) 106. The server(s) 106 may generate, track, store, process, receive, and transmit electronic data, such as results, actions, determinations, responses, computer code, interactions with interface elements, and/or interactions between user accounts or client devices. For example, the server(s) 106 may receive an indication from the client device(s) 114a-114n or the administrator client device 118 of a user interaction selecting an option that initiates a task or inputting text comprising actions or prompts to generate a specific output. In addition, the server(s) 106 can transmit data to the client device(s) 114a-114n or the administrator client device 118. Indeed, the server(s) 106 can communicate with the client device(s) 114a-114n or the administrator client device 118 to send and/or receive data via network 124. In some implementations, the server(s) 106 comprise(s) a distributed server where the server(s) 106 include(s) a number of server devices distributed across the network 124 and located in different physical locations. The server(s) 106 can comprise one or more content servers, application servers, container orchestration servers, communication servers, web-hosting servers, machine-learning servers, and other types of servers.

As shown in FIG. 1, the server(s) 106 can also include the context determination system as part of the experience management system 104. The experience management system 104 can communicate with the client device(s) 114a-114n to perform various functions associated with the client application(s) 116a-116n, such as managing accounts, initiating tasks, and/or receiving user preferences. Indeed, experience management system 104 can manage, store, and maintain user profiles and preferences associated with the client device(s) 114a-114n. In some embodiments, the context determination system 102 and/or the experience management system 104 utilize the database 112 to store and access information pertaining to user profiles, user preferences, topics, or other data related to determining contexts for interactions.

As also illustrated in FIG. 1, the experience management system 104 can host a large language model 108. In particular, the experience management system 104 can host a large language model 108 local to the experience management system 104 that is trained to determine contexts utilizing information from the experience management system 104. For example, large language model 108 operates within a firewall of the experience management system 104, utilizing secure data and information that is part of the experience management system 104.

In addition, as illustrated in FIG. 1, the experience management system 104 can host a topic model 110. In particular, topic model 110 is a system, document, or database comprising topics and information related to experiences and journeys. In some cases, topic model 110 communicates with the administrator client device 118 to receive selections or input of topics for topic model 110 in order to generate a taxonomy of topics.

As also shown in FIG. 1, environment 100 also includes the third-party server(s) 120 that host the third-party large language model(s) 122. In particular, the third-party large language model(s) 122 communicate with the server(s) 106 and/or the database 112 to receive a prompt and generate interactions and/or interaction contexts for engagement data. For example, the context determination system 102 provides a prompt (e.g., a contextual prompt) to the third-party large language model(s) 122 that instructs the third-party large language model(s) 122 to identify interactions, interaction contexts, and/or sentiments found within engagement data. In some cases, the third-party machine-learning model(s) 122 refers to various third-party machine-learning models (e.g., ChatGPT, Lambda, Llama, BERT, RoBERTa, Turing-NLG, T5, XLNet).

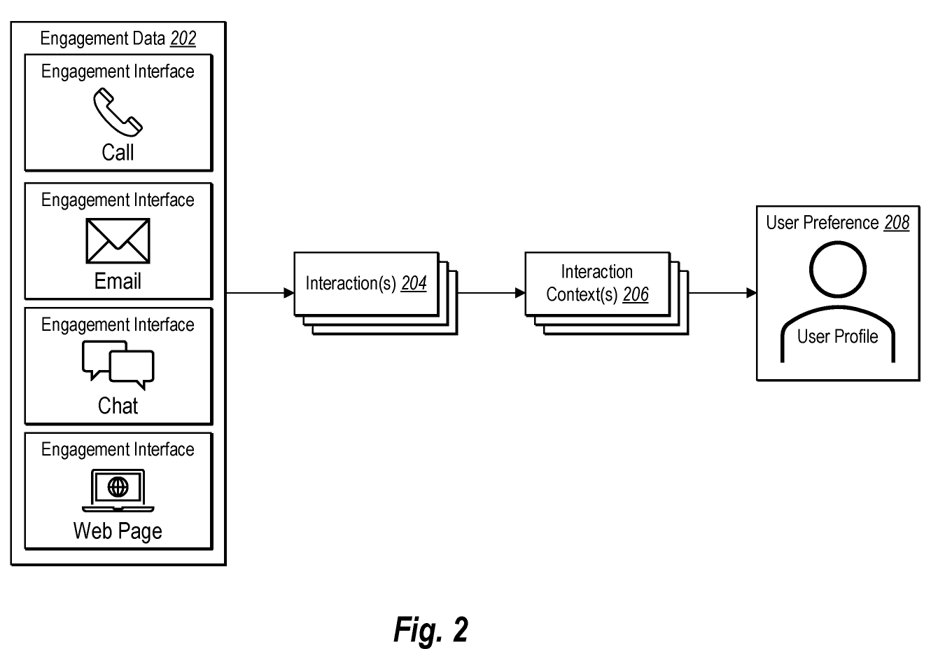

As mentioned, the context determination system 102 can intelligently generate interactions from engagement data and determine a context for each interaction. In particular, context determination system 102 can generate interactions for engagement data corresponding to a user engagement event with an engagement interface, determine an interaction context for each interaction, and update a user profile based on user preferences extracted from the interaction context. FIG. 2 illustrates a schematic diagram of an example overview of a context determination system generating interactions from engagement data and determining interaction contexts for the interactions in accordance with one or more embodiments.

As illustrated in FIG. 2, the context determination system 102 receives engagement data 202 corresponding to a user engagement event. Specifically, a user engagement event is a communication or discourse between entities where data, ideas, or information is exchanged. For example, engagement data 202 can include a transcript from a call, email, chat exchange, and messaging application exchange.

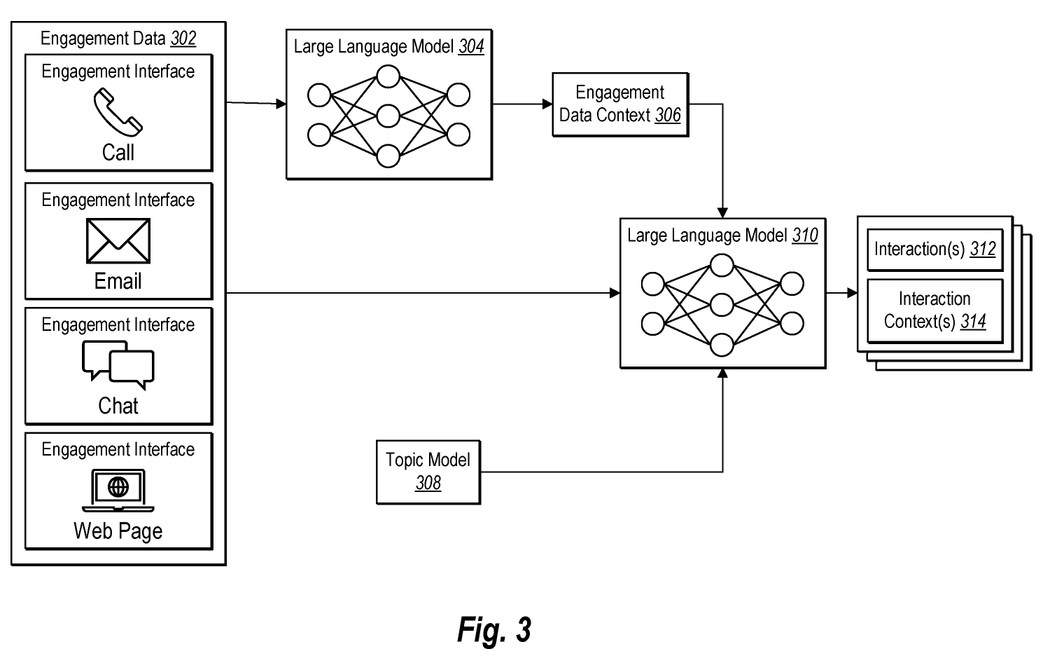

In addition, as shown in FIG. 2, engagement data 202 can comprise data from a myriad of different engagement interfaces. In particular, the context determination system 102 receives engagement data from an engagement interface that facilitates a user engagement event between entities and provides data corresponding to the interaction. In some cases, an engagement interface includes a device or other hardware system, such as client devices, recording systems, or servers. In other cases, an engagement interface refers to a software system that facilitates user engagement events, such as an email, mobile application, messaging applications, or services. Additional detail regarding the context determination system 102 receiving engagement data corresponding to user engagement events and engagement interfaces is provided with respect to FIG. 3 below.

As also shown in FIG. 2, the context determination system 102 generates interaction(s) 204 from engagement data. Specifically, the context determination system 102 generates one or more interactions from engagement data that comprise a discrete component or exchange in a user engagement event. Throughout a user engagement event, entities may discuss a number of different products, services, or ideas and engagement data can comprise a single interaction or multiple interactions. The context determination system 102 intelligently and efficiently identifies interactions in the engagement data, whether there is a single interaction or multiple interactions.

In one or more embodiments, the context determination system 102 can identify multiple interactions in experience data. In particular, context determination system 102 can determine multiple interactions and corresponding interaction contexts from a single instance of engagement data. For example, context determination system 102 can identify that a call, email, or chat comprises multiple interactions and generate interaction contexts for each interaction.

Additionally, in one or more embodiments, the context determination system 102 utilizes a large language model to generate an interaction from engagement data 202. In particular, the context determination system 102 provides the engagement data (or a portion of the engagement data) along with a prompt to a large language model to generate an interaction from the engagement data. A large language model can include a trained large language model of the context determination system 102 or a third-party large language model. In some cases, the large language model is trained to identify interactions from engagement data. In other cases, the large language model generates the interaction based on the prompt from the context determination system 102. Additional details regarding the context determination system 102 utilizing a large language model to generate an interaction are provided with respect to FIG. 3 below.

As also illustrated in FIG. 2, the context determination system 102 determines interaction context(s) 206 for interaction(s) 204. Specifically, the context determination system 102 determines interaction context(s) 206, which indicates (or denotes) intents, motivations, or other factors for the interaction. To illustrate, the context determination system 102 can identify an interaction of a service for a car and identify the context that the interaction is a cost complaint for a twenty-thousand-mile service. In one or more embodiments, the context determination system 102 also determines an additional interaction context for an interaction. To illustrate, the context determination system 102 can also identify an additional context that the service is expensive.

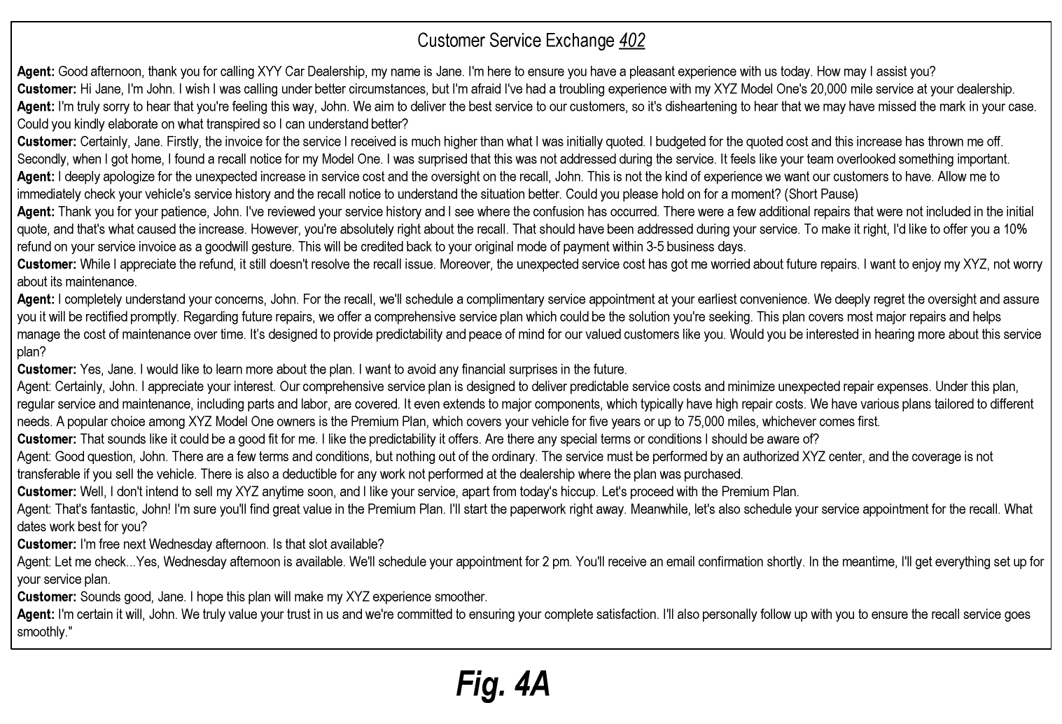

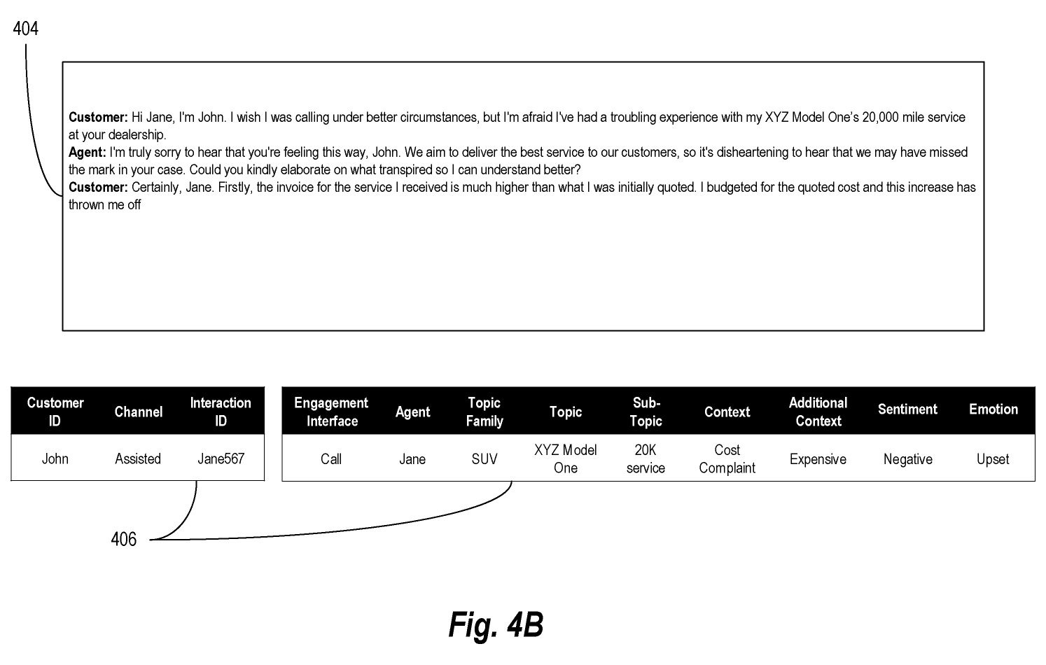

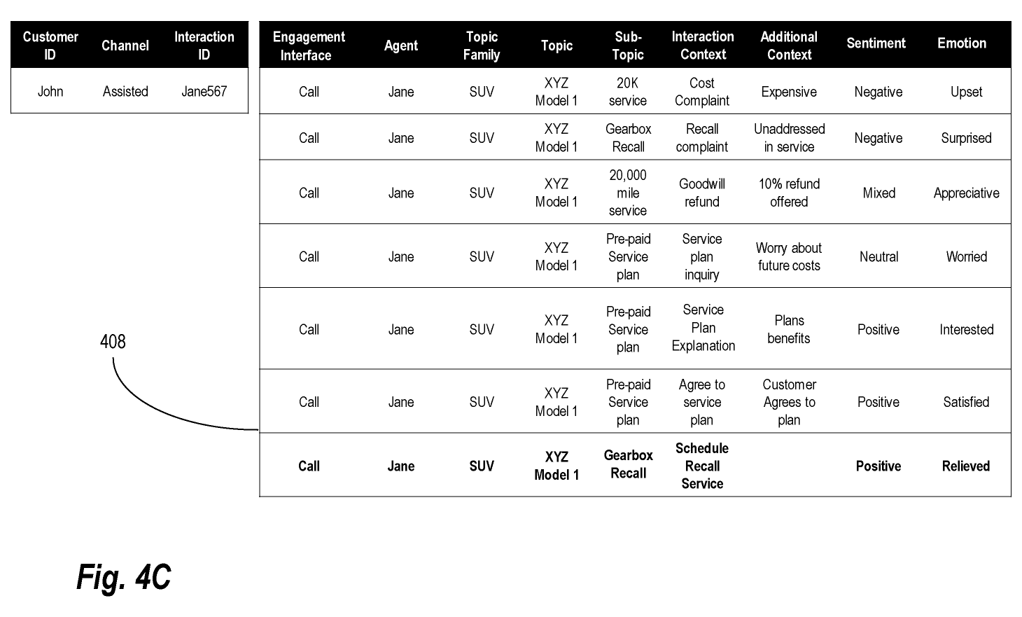

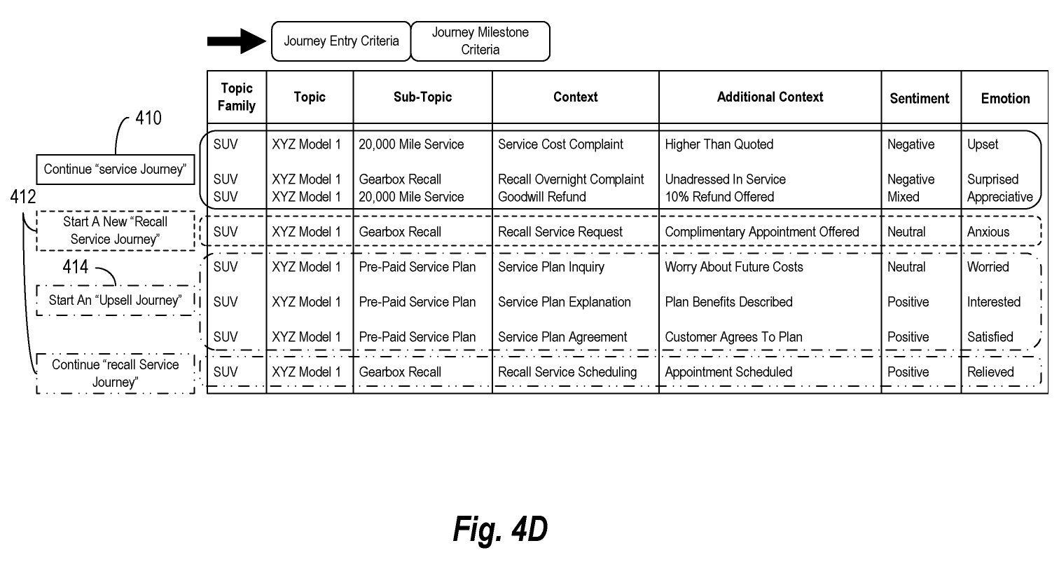

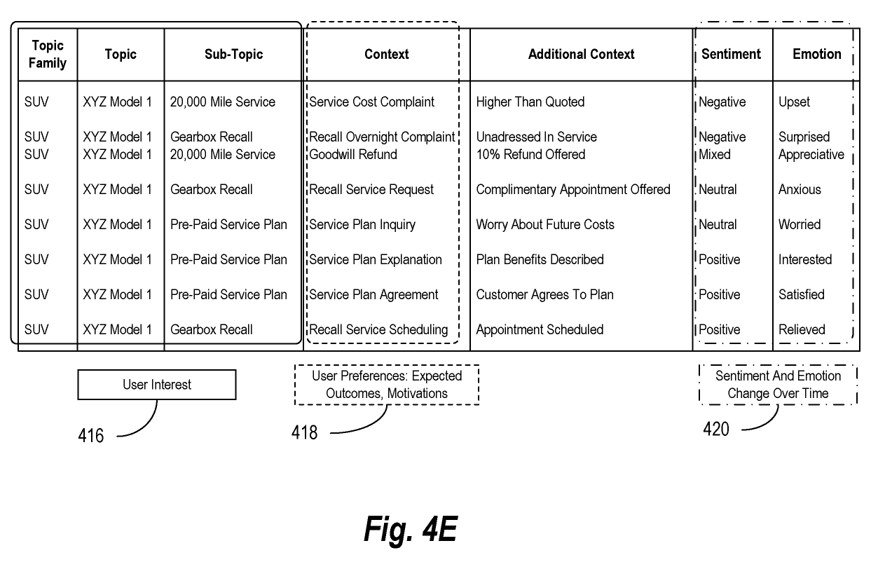

In one or more embodiments, the context determination system 102 utilizes a large language model to determine an interaction context for the interaction. Specifically, the context determination system 102 can provide a prompt to a large language model for the large language model to identify a context for an interaction. In some cases, the context determination system 102 provides a prompt that instructs the large language model to identify interactions and interaction contexts from engagement data. Additional detail regarding the context determination system 102 identifying interactions and interaction contexts is provided with respect to FIG. 3 and FIGS. 4A-4E below.

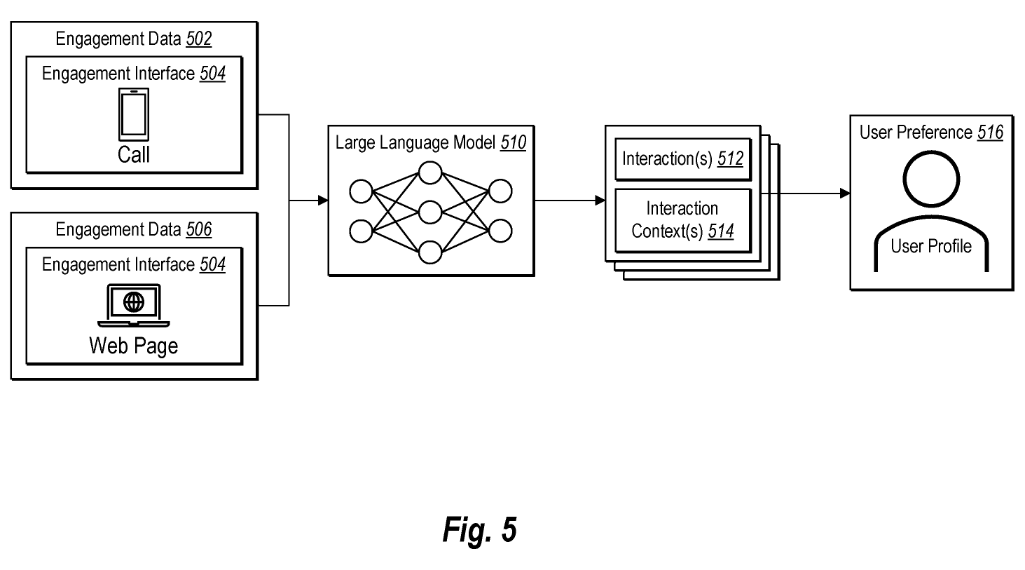

Additionally, in one or more embodiments, the context determination system 102 extracts content from engagement data to generate an interaction context. In particular, the context determination system 102 extracts content by extracting data related to a user engagement event and utilizes the content to generate the interaction context. For example, the context determination system 102 can extract content from a webpage or mobile application with which a client device associated with the user profile interacted and utilize the content to generate an interaction and corresponding interaction context. In some cases, the context determination system 102 also extracts conversation segments from content. Additional detail regarding the context determination system 102 extracting content and utilizing the content to generate an interaction and corresponding interaction context is provided with respect to FIG. 5 below.

In one or more embodiments, the context determination system 102 utilizes the interaction context to identify or associate an experience journey. Specifically, the context determination system 102 can identify, based on the interaction context, that the interaction corresponds to a touchpoint of an experience journey and associate the interaction with an experience journey for the user. For example, the context determination system 102 utilizes the interaction context to determine that an interaction corresponds to an initiation touchpoint for an experience journey and initiate tracking an experience journey for the user profile associated with the interaction. As another example, the context determination system 102 utilizes the interaction context to determine that the interaction corresponds to an intermediate touchpoint of an experience journey associated with the user profile (e.g., an existing experience journey) and associates the interaction with the experience journey. Additional information regarding the context determination system 102 utilizing interaction context to identify experience journeys is provided with respect to FIGS. 4A-4E below.

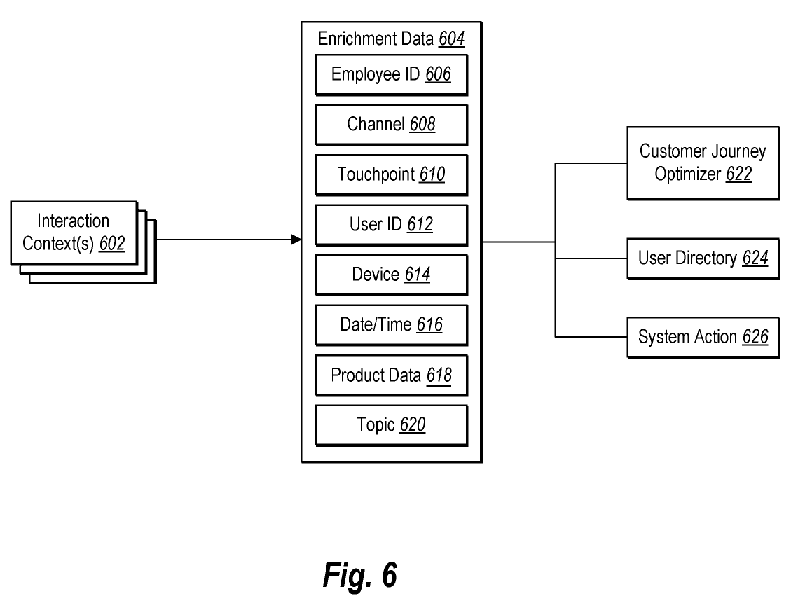

In an additional example, the context determination system 102 utilizes the interaction context to determine an additional or next touchpoint for an experience journey. In particular, the context determination system 102 determines a next journey touchpoint in an experience journey and determines (and executes) a system action with respect to the user profile. For example, the context determination system 102 can provide content, request feedback, or personalized recommendations to a client device (or client application) associated with the user profile. Additional information regarding next journey touchpoints and system actions is provided with respect to FIG. 6 below.

As also shown, the context determination system 102 identifies a user preference 208 for a user profile. In particular, the context determination system 102 extracts a user preference 208 from an interaction context and applies the user preference to a user profile. For example, the context determination system 102 extracts a user preference by retrieving or identifying interests, motivations, intents, wants, needs, demographics, or personalized content from the interaction context. To illustrate, the context determination system 102 can identify, based on interaction context, that a person is concerned with costs associated with maintaining a car. Indeed, as the context determination system 102 identifies contexts from various interactions throughout various user engagement events, the context determination system 102 can generate (or add to) a user profile, creating a detailed user profile that the experience management system 104 can utilize to provide personalized recommendations or actions. Additional detail regarding the context determination system 102 extracting user preferences is provided with respect to FIG. 5 below.

The context determination system 102 can also update user preferences with user preferences across multiple user engagement events across multiple engagement interfaces. In particular, the context determination system 102 receives a first.

In one or more embodiments, the context determination system 102 utilizes enrichment data when determining an interaction context. Specifically, the context determination system 102 adds to or enriches an interaction context generated by a large language model with enrichment data for a user profile. For example, the context determination system 102 can utilize a third-party large language model to generate an interaction context and then add enrichment data that includes secure data associated with a user profile. Additional detail regarding the context determination system 102 adding enrichment data to interaction contexts is provided with respect to FIG. 6 below.

As previously mentioned, in one or more embodiments, the context determination system 102 utilizes a large language model to generate an interaction and an interaction context from engagement data. In particular, the context determination system 102 can identify a topic, extract content from the engagement data, and provide the topic and the content as part of a contextual prompt for the large language model to generate the interaction and interaction context for the engagement data. FIG. 3 illustrates a schematic diagram of the context determination system 102 utilizing a large language model to generate an interaction and determine an interaction context from engagement data in accordance with one or more embodiments.

As shown in FIG. 3, the context determination system 102 receives engagement data 302. As previously mentioned, the context determination system 102 receives engagement data 302 from a corresponding user engagement event with an engagement interface. An engagement interface, for example, is a device, system, application, or service that facilitates entities to interact, communicate, or exchange data. In one or more embodiments, an engagement interface can refer to hardware or devices through which words, data, or other information is exchanged. For example, an engagement interface can refer to a client device, such as a smartphone, a tablet, a smart television, a desktop computer, a laptop computer, a virtual reality device, an augmented reality device, another computing device, or landline telephone. In addition to various computing devices, an interface may also include various other devices that record spoken interactions, such as a video camera, security camera, or audio recording device. Additional detail regarding client devices is provided in FIGS. 8-9 below.

In addition to client devices or other hardware devices, in one or more embodiments, an engagement interface refers to software systems or applications that facilitate exchanges between entities. Specifically, an engagement interface includes a system that facilitates interaction, communication, or data exchange of text, video, audio, or other forms of communication. For example, based on the exchange between entities in the engagement interface the context determination system 102 can receive engagement data comprising unstructured text that represents or depicts the exchange from a software system. To illustrate, an engagement interface can be an email server, a chat or messaging service, a web browser, or a mobile application.

Moreover, in one or more embodiments, an engagement interface includes a graphical user interface with which a client device accesses or interacts. In particular, the context determination system 102 identifies that a client device associated with a user profile of the context determination system 102 (or experience management system 104) accessed content and receives engagement data corresponding to the content. For example, the context determination system 102 identifies that a client device accessed a web page through a web browser and extracts content from the web page the client device accessed (e.g., through extracting the content from the web page). The context determination system 102 then utilizes the extracted content from the web page as engagement data. To illustrate, the context determination system 102 can utilize a URL to parse and extract data from the webpage and utilize the extracted data as engagement data.

As just mentioned, the context determination system 102 extracts content from web pages. In addition, in one or more embodiments, the context determination system 102 extracts content from other types of engagement data 302. Specifically, the context determination system 102 can identify that engagement data from a user engagement interaction comprises additional data or other information that is not related to the user engagement interaction and extracts engagement data that is pertinent to the interaction. For example, the context determination system 102 can extract content from a call center script that is pertinent to the user engagement interaction. To illustrate, the context determination system 102 can extract unstructured text that relates to the user engagement interaction (e.g., the transcript or text related to the interaction) that does not include data related to facilitating the user engagement interaction. In some cases, the context determination system 102 does not extract filler text (or data), system data, blank spaces, or other information not related to the user interface interaction.

In addition, in one or more embodiments, the context determination system 102 extracts conversation segments from content. In particular, the context determination system 102 extracts conversation segments relating to a portion of a content that pertains to a conversation. For example, the context determination system 102 extracts a conversation segment by extracting a portion of dialogue that focuses on a specific topic or idea.

Also, in one or more embodiments, the context determination system 102 extracts content by utilizing additional systems to extract content. Specifically, the context determination system 102 could use a third-party system to extract unstructured text from a user engagement interaction. For example, the context determination system 102 could utilize optical character recognition (OCR) to extract text from a document or other representation of a user engagement interaction. As another example, the context determination system 102 could use a third-party system or device to extract unstructured text from a video call. In another example, the context determination system 102 can utilize a third-party service to extract unstructured text corresponding to an email thread.

As shown in FIG. 3, the context determination system 102 utilize a large language model 304 to generate an engagement data context 306. In particular, the context determination system 102 provides engagement data 302 to large language model 304 to generate an engagement data context 306 that indicates an overall context for the engagement data. For example, large language model 304 could determine that an engagement data context is “complaint about car service” for a set of engagement data. As another example, large language model 304 could determine an engagement data context of “viewing car specifications” on a web page.

As shown in FIG. 3, in one or more embodiments, the context determination system 102 provides engagement data 302, engagement data context 306, and topic model 308 to large language model 310 to determine interaction(s) 312 and interaction context(s) 314. Specifically, the context determination system 102 generates a prompt comprising the engagement data (or content extracted from the engagement data), the engagement data context 306, and topic model 308 with an instruction for large language model 310 to identify interaction(s) 312 and interaction context(s) 314. To illustrate, the context determination system 102 can generate a prompt that instructs large language model 310 to act as a natural language processing model and utilize the engagement data context 306 and the topic model 308 to discover references to products, conversation topics, sentiment, and emotion and analyze the engagement data 302 (or the content) to generate a list of events. In some cases, the large language model 304 and the large language model 310 are the same large language model. In other cases, the context determination system 102 utilizes separate large language models as large language model 304 and large language model 310.

As mentioned, the context determination system 102 provides topic model 308 to large language model 310 to generate interaction(s) 312 and interaction context(s) 314. In particular, the context determination system 102 (or the experience management system 104) utilizes topic models of databases, systems, or documents comprising keywords, phrases, or terms that correspond to various topics (including topic families, topics, and subtopics). The context determination system 102 analyzes experience data to identify or determine whether words, phrases, or subjects in the experience data correspond to topics in the topic model. For example, the context determination system 102 can identify that experience data of a transcript of a call between a customer service agent and a user device corresponds to a topic family of “SUV,” with a topic “model x,” and the subtopics “20K mile service,” “recall complaint,” “service plan inquiry,” and “service plan explanation.”

In addition, in one or more embodiments, the context determination system 102 (or the experience management system 104) maintains topic models corresponding to various general topics. Specifically, the context determination system 102 (or the experience management system 104) maintains topics corresponding to certain classes or categories of products, goods, or services. For example, the context determination system 102 (or experience management system 104) can maintain topic models that are associated with classes of products, goods, or services. To illustrate, the context determination system 102 can maintain topic models for topics such as sports, finance, food, or vehicles.

Moreover, in one or more embodiments, the context determination system 102 can provide infrastructure to build a topic model. Specifically, the context determination system 102 can provide a user interface and corresponding system for an administrator client device to input data or other information corresponding to a particular product, service, good, or brand. For example, an administrator device can provide input comprising keywords, phrases, or terms specific to their product, good, service, or brand. To illustrate, an administrator device of a vehicle company could generate a topic model that includes a topic family “SUV,” with topics of their various models of vehicles (e.g., Model X for Tesla), with subtopics relating to various aspects of that model (e.g., 20K mile service, service plan inquiries, recalls).

Further, in one or more embodiments, a topic model is updated or changed based on user input. Specifically, in cases where a topic model is a database or document, the context determination system 102 (or the experience management system 104) can receive input adding or removing topic families, topics, or subtopics. For example, the context determination system 102 (or the experience management system 104) can receive input removing a discontinued product. As another example, the context determination system 102 can receive input adding topics (or topic families or subtopics) corresponding to a new product.

In one or more embodiments, a topic model utilizes machine-learning models to identify topics for a topic model. Specifically, the context determination system 102 (or the experience management system 104) utilizes machine-learning models trained to identify or classify topics in unstructured text. In some cases, the context determination system 102 utilizes a supervised learning approach and trains the machine-learning model using annotated data and predefined topics. The context determination system 102 generates a topic and compares the generated topic with the ground truth topics (annotated data and predefined topics) and adjusts parameters of the machine-learning model utilizing a loss function (e.g., by back-propagating on the loss). In other cases, the context determination system 102 utilizes an unsupervised approach and utilizes a machine-learning model to identify topics based on patterns, such as word clusters and their associated frequencies.

As mentioned, the context determination system 102 generates interactions from unstructured text of engagement data, determines interaction contexts for each interaction, and utilizes the interaction contexts to extract user preferences. Moreover, the context determination system 102 utilizes the interaction context to identify or associate experience journey touchpoints to a user profile. FIGS. 4A-4E illustrates an example of a context determination system generating interactions from example engagement data, determining interaction contexts, and associating the interaction context to experience journeys of a user profile in accordance with one or more embodiments.

In one or more embodiments, the context determination system 102 generates additional contexts for an interaction. Specifically, an additional context adds additional information or focus of the interaction. For example, the context determination system 102 can instruct large language model 310 as part of prompt to identify additional contexts for interactions. To illustrate, the context determination system 102 identifies a context of “cost complaint” for an interaction and an additional context of “expensive,” denoting that the user associated with the cost complaint was concerned about the expense of a service or good (e.g., as opposed to the value of the service).

As mentioned, the context determination system 102 receives engagement data that comprises unstructured text from user engagement events. As shown in FIG. 4A, the context determination system 102 receives customer service exchange 402, which is a transcript from a call between a client device associated with a user of the experience management system and an agent. The context determination system 102 can then generate interactions and corresponding interaction contexts from customer service exchange 402. In particular, the context determination system 102 can provide the customer service exchange 402 as part of a prompt for a large language model to generate interactions and corresponding interaction contexts.

As shown in FIG. 4B, the context determination system 102 identifies an interaction 404 from customer service exchange 402. In particular, the context determination system 102 identifies a salient portion of text that comprises an exchange of an idea, topic, or subject. In particular, the context determination system 102 identified a context of “cost complaint” for the interaction, with the related additional context of “expensive” for the cost complaint. Indeed, the context determination system 102 can instruct the large language model (in a prompt) to identify additional interaction contexts for the engagement data.

Moreover, as shown in FIG. 4B, the context determination system 102 can also determine sentiment and emotion for the interaction. Specifically, the context determination system 102 can identify a sentiment and emotion that are related to only that interaction found in the engagement data. For example, when referring to the cost complaint for the 20K service, the sentiment is “negative,” and the emotion is “upset.” Indeed, the context determination system 102 can efficiently and accurately determine topics, contexts, sentiments, and emotions all with a single prompt to a large language model.

In addition, as shown in FIG. 4B, the context determination system 102 can also associate contexts, topics, sentiment, and emotion for interaction 406. For example, the context determination system 102 can associate the information in a database, document, or application. As also shown in FIG. 4B, the context determination system 102 can display enrichment data of a customer ID, channel, and interaction ID as part of interaction 406. In particular, the context determination system 102 can identify and associate enrichment data comprising additional information or secure information with the interaction. Additional detail regarding the context determination system 102 associating enrichment data to an interaction is provided with respect to FIG. 6 below.

As mentioned, the context determination system 102 can identify multiple interactions and associated interaction contexts from an instance of engagement data. As shown in FIG. 4C, the context determination system 102 identifies interactions 408 by identifying multiple interactions from customer service exchange 402. In particular, the context determination system 102 can construct a prompt for a large language model to identify interactions, interaction contexts, sentiments, and emotions for the customer service exchange 402. Indeed, the context determination system 102 can identify all the interactions, interaction contexts, sentiments, and emotions for customer service exchange 402 with a single prompt to a large language model.

In one or more embodiments, the context determination system 102 can also display interactions 408 in a graphical user interface. Specifically, the context determination system 102 can display individual interactions or multiple interactions on an administrator device as part of an application of the experience management system 104. For example, the context determination system 102 or the experience management system 104 can generate the graphical user interface that allows the administrator client device to view individual interactions or multiple interactions from engagement data.

As previously mentioned, the context determination system 102 can associate an interaction with an experience journey. In particular, an instance of engagement data can reference multiple experience journeys, and the context determination system 102 can identify individual experience journeys in an instance of engagement data. FIG. 4D illustrates various experience journeys identified by the context determination system 102 in customer service exchange 402.

In one or more embodiments, the context determination system 102 can identify an experience journey associated with the user profile based on user interactions corresponding to touchpoints of an experience journey. The context determination system 102 (or the experience management system 104) maintains various experience journeys with pre-defined touchpoints. Specifically, the pre-defined templates indicate touchpoints of an experience journey that indicate likely interaction points that a user or client device will pass as part of the experience journey. For example, the context determination system 102 identifies that an interaction is a touchpoint of an experience journey based on identifying that the interaction corresponds to a touchpoint of an experience journey.

The context determination system 102 identifies that interactions correspond to touchpoints corresponding to touchpoints that correspond to different portions of an experience journey. For example, the context determination system 102 can identify that an interaction corresponds to an intermediate touchpoint of an experience journey associated with a user profile. An intermediate touchpoint can correspond to a touchpoint that occurs during an experience journey, but that does not start an experience journey (e.g., it is not an initiation touchpoint). As shown in FIG. 4D, interactions 410 correspond to a “service journey,” which is an experience journey that was associated with the user profile prior to the user engagement event corresponding to customer service exchange 402 (e.g., the phone call). For example, the user profile may have previously begun an experience journey with a previous user engagement event (e.g., a previous call, interaction with a website, email, or input from an in-person exchange with an agent).

In addition to identifying intermediate touchpoints, the context determination system 102 can identify initiation touchpoints for experience journeys. In particular, in one or more embodiments, the context determination system 102 identifies that an interaction corresponds to an initiation touchpoint for an experience journey and initiates tracking of an experience journey. As shown in FIG. 4D, the context determination system 102 identifies that interactions 412 correspond to an initiation touchpoint and intermediate touchpoint of an experience journey that is a “recall service journey” and that interactions 414 correspond to an initiation touchpoint and intermediate touchpoints of an experience journey that is a “upsell journey.” Indeed, as shown in FIG. 4D, the context determination system 102 can identify that interactions 412 correspond to the “recall service journey” even though the interactions are not sequential in customer service exchange 402 (e.g., interactions 414 happen in between the initial touchpoint and intermediate touchpoints for the recall service journey).

As previously mentioned, the context determination system 102 can extract user preferences from interaction contexts in order to update user preferences of a user profile. FIG. 4E illustrates examples of the context determination system 102 extracting user interests, user preferences, sentiments, and emotions from the interaction contexts. As shown, in one or more embodiments, the context determination system 102 can extract user interests 416 from interactions based on topics identified in the interactions. Specifically, the context determination system 102 can identify that a user interacts with content pertaining to or discusses a topic corresponding to a product, service, or good and updates a user profile with a user interest corresponding to the topic.

As also shown, the context determination system 102 can extract user preferences 418 from interaction contexts. Specifically, the context determination system 102 identifies expected outcomes, motivation, wants, intents, or personalized content from the interaction contexts. For example, based on interaction contexts, the context determination system 102 determines that a user prefers to book reservations online rather than call, that a user owns a certain product (e.g., a model of a car), or that a user is concerned about cost.

Moreover, the context determination system 102 can extract user preferences based on sentiment 420. In particular, as shown in FIG. 4E, the context determination system 102 can identify user preferences based on a sentiment 420 and/or emotion change over time. For example, the context determination system 102 can identify that a user started upset with their product but became pleased after the user engagement interaction. As another example, the context determination system 102 can update a user preference of the user profile that indicates the user profile appears satisfied with the product (e.g., will now be okay with receiving information related to that product).

As previously mentioned, the context determination system 102 can identify user preferences from multiple user engagement events. In particular, the context determination system 102 receives multiple sets of engagement data from multiple user engagement events that correspond to a user profile and updates the user profile with user preferences based on the interactions. FIG. 5 illustrates a schematic diagram of a context determination system receiving engagement data from multiple engagement interfaces and updating a user profile within an experience management system in accordance with one or more embodiments.

As previously mentioned, the context determination system 102 receives engagement data that corresponds to user engagement events with different engagement interfaces. In particular, the context determination system 102 can identify that different user engagement events with different user engagement interfaces are related to each other. For example, the context determination system 102 can identify that multiple user engagement events correspond to the same product, service, or good. As shown, the context determination system 102 receives engagement data 502 corresponding to a user engagement event corresponding to a user engagement event with engagement interface 504, which represents a first type of engagement interface (e.g., a phone or other calling device) and engagement data 506 corresponding to a user engagement event with engagement interface 504, which represents a second type of engagement interface (e.g., a web browser).

In one or more embodiments, the context determination system 102 identifies that user engagement events with multiple engagement interfaces are related based on interaction context. For example, as shown in FIG. 5, the context determination system can provide engagement data 502 and engagement data 506 to large language model 510 to determine interaction(s) 512 with corresponding interaction context(s) 514. Based on the interaction context, the context determination system 102 can determine that the user engagement interactions are related to each other.

Moreover, in one or more embodiments, the context determination system 102 can also utilize the interaction context(s) 514 to correlate sentiment to the user engagement event. In particular, the context determination system 102 can utilize the interaction context(s) 514 to identify which user interactions prompted a particular user sentiment. For example, if a user made a reservation online and also made a phone call about the reservation, the context determination system 102 can generate interactions and corresponding interaction contexts for the interactions that can identify context for (or reasonings behind) the sentiment. Indeed, the context determination system 102 can correlate the behavior associated with the user profile to feedback associated with the user profile (or vice versa).

In addition to identifying that user engagement events are related, the context determination system 102 utilizes multiple user engagement events across multiple engagement interfaces to determine (or update) user preference 516 for a user profile. Specifically, the context determination system 102 can identify that a user profile tends to be correlated with certain behaviors on certain interfaces and update a user profile with the corresponding user preferences. For example, the context determination system 102 may identify that bookings and reservations associated with the user profile are generally made through a mobile application on a mobile device and update a user profile with a preference for booking online. As another example, the context determination system 102 can identify based on interaction context(s) from interactions across multiple engagement interfaces that the user profile is concerned with cost.

In addition, the context determination system 102 can identify touchpoints of experience journeys across various engagement interfaces. Specifically, the context determination system 102 can identify a touchpoint for an experience journey from one engagement interface and an additional touchpoint for the experience journey from an additional engagement interface. For example, a user profile may start or initiate an experience journey through a user engagement interaction on one engagement interface and then continue the experience journey through an additional user engagement interaction on an additional engagement interface. To illustrate, a user profile may begin a rental car reservation experience journey on a client application on a client device and then continue the rental car reservation experience journey through a phone call with an agent of the rental car company. The context determination system 102 can generate interactions from each user engagement event and identify that they are associated with the same journey.

As previously mentioned, the context determination system 102 can also associate enrichment data with interaction contexts. In particular, the context determination system 102 associates enrichment data that identifies secure data corresponding to the user profile to the interaction. FIG. 6 illustrates a schematic diagram of a context determination system associating enrichment data to interactions in accordance with one or more embodiments.

As previously mentioned, in one or more embodiments, the context determination system 102 utilizes a large language model to generate an interaction or interaction context. In some cases, the large language model is a third-party large language model external to the context determination system 102 (or the experience management system 104). To protect secure user data, the context determination system 102 provides a prompt to the large language model that does not comprise secure data and adds enrichment data to interactions (or interaction contexts) generated by the large language model. As shown, the context determination system 102 adds enrichment data 604 to interaction context(s) 602 generated by a large language model.

In one or more embodiments, enrichment data 604 comprises data or other identifiers associated with a user profile of the experience management system or with other components of the experience management system. As shown, enrichment data 604 can comprise an employee ID 606. In some cases, employee ID 606 can refer to an identification (e.g., a number, title, or indicator) of an employee with which the user profile interacted during a user engagement interaction. For example, a user device associated with a user profile of the experience management system can interact with another user device that is associated with an employee ID of the experience management system.

As also shown, enrichment data 604 can comprise channel 608. In some cases, channel 608 can refer to a channel of the experience management system with which the user engagement event corresponds. For example, the context determination system 102 adds (or applies) additional information to the interaction based on channel 608. In some cases, the context determination system 102 can associate interaction context(s) 602 to an experience journey based on a channel of the experience management system. In other cases, context determination system 102 can correlate user preferences to a user directory based on channel 608.

In addition, as shown, enrichment data 604 can comprise touchpoint 610. In particular, touchpoint 610 can refer to a touchpoint of an experience journey. For example, as previously mentioned, the context determination system 102 or the experience management system 104 can maintain experience journeys corresponding to various goods, services, or products, and the context determination system 102 can associate enrichment data to interaction by associating the interaction to a touchpoint of the experience journey.

Further, as shown, enrichment data 604 can include a user ID 612. Specifically, user ID 612 can refer to a user ID of an experience management system. For example, a user ID can include identification information of a user profile, such as name, birth date, email, or address. In some cases, a user ID can be an identification specific to the experience management system (e.g., a username for the experience management system).

In addition, as shown, enrichment data 604 can include device 614. In particular, device 614 can refer to identification data for a device from which the context determination system 102 receives user engagement data. For example, a device can refer to hardware identifiers (e.g., mac address, serial number), network identifiers (e.g., IP address or hostname), application identifiers for a device, or security identifiers (e.g., FIDO).

Moreover, as shown, enrichment data 604 can include a data/time 616. Specifically, data/time 616 can refer to a date and/or time associated engagement data. For example, the context determination system 102 can receive an indication of a data and/or time as a part of engagement data or metadata associated with the engagement data and associate the interaction context(s) 602 based on date/time 616.

Also, as shown, enrichment data 604 can include a product data 618. Specifically, the context determination system 102 can receive or determine a product associated with the engagement data and can associate the product data 618 to the context. For example, if the context determination system 102 determines an interaction context is associated with a BMW, the context determination system 102 can utilize product data 618 that incorporates specifications, information, and other data of the product. To illustrate, product data 618 could indicate that there is a recall on the BMW indicated in the interaction context.

As shown, enrichment data 604 can also include a topic 620. Specifically, topic 620 indicates a group of similar concepts or themes and, in some cases, relates the interaction context(s) 602 to a topic family. For example, the context determination system 102 can indicate a topic “Model M” and a topic family “BMW” for the topic family.

In one or more embodiments, the context determination system 102 comprises a large language model local to (e.g., within the firewall) the context determination system 102. In these instances, the context determination system 102 does not add enrichment data to interactions. Indeed, because data does not leave the context determination system 102 and, therefore, the data remains secure within the system, the context determination system 102 can provide a prompt to the large language model with enrichment data rather than associating enrichment data after a large language model generates interactions.

In addition to adding enrichment data, the context determination system 102 can perform additional actions or utilize the interaction contexts to perform additional actions. As shown, in one or more embodiments, the context determination system 102 can utilize interaction context(s) to update a customer journey optimizer 622. Specifically, the context determination system 102 can update a customer journey optimizer 622 with the interaction context to update an experience journey. In some cases, the context determination system 102 will update an experience journey associated with a user. In other cases, the context determination system 102 identifies, based on the interaction context, that user profiles associated with an experience journey are also associated with an interaction and update touchpoints of an experience journey within the customer journey optimizer. For example, the context determination system 102 can add an additional intermediate touchpoint to an existing experience journey that corresponds to the interaction.

In one or more embodiments, the context determination system 102 can identify additional experience journeys to add to the customer journey optimizer based on the interaction context. Specifically, the context determination system 102 identifies, based on the interaction context, that the interaction corresponds to a good, service, or product for which there is not an experience journey and generate an experience journey to correspond to the interaction. For example, the context determination system 102 can identify from the interaction context that the interaction corresponds to a new product for which there is not an experience journey and generate an experience journey for the product. In some cases, the context determination system 102 can utilize an experience journey template to generate the experience journey. In other cases, the context determination system 102 builds an experience journey by selecting options to generate an experience journey.

As also shown, in one or more embodiments, the context determination system 102 can utilize the interaction context(s) to update a user directory 624. In particular, the context determination system 102 updates user directory 624 with user preferences extracted from interaction context(s) 602. User directory 624 can include a compilation of user profiles with corresponding user preferences and which experience management system 104 can utilize to provide customized user experiences. By updating user directory 624 with user preferences, experience management system 104 can perform action actions customized to the unique user preferences of a user profile.

In addition, as shown, the context determination system 102 can execute a system action 626. In particular, the context determination system 102 can determine a system action corresponding to the interaction context(s) and execute the system action. For example, a system action can include transmitting an electronic communication, generating a digital ticket, updating digital survey distribution data, adding data identifying or generating an orchestration trigger, adding or inserting code into a software application, or transmitting data to a third-party server, and a variety of other system actions. In certain implementations, a system action includes one or more bulk actions (e.g., large batches of actions performed over and over). For instance, a system action can include myriad different digital tasks across a variety of computing devices.

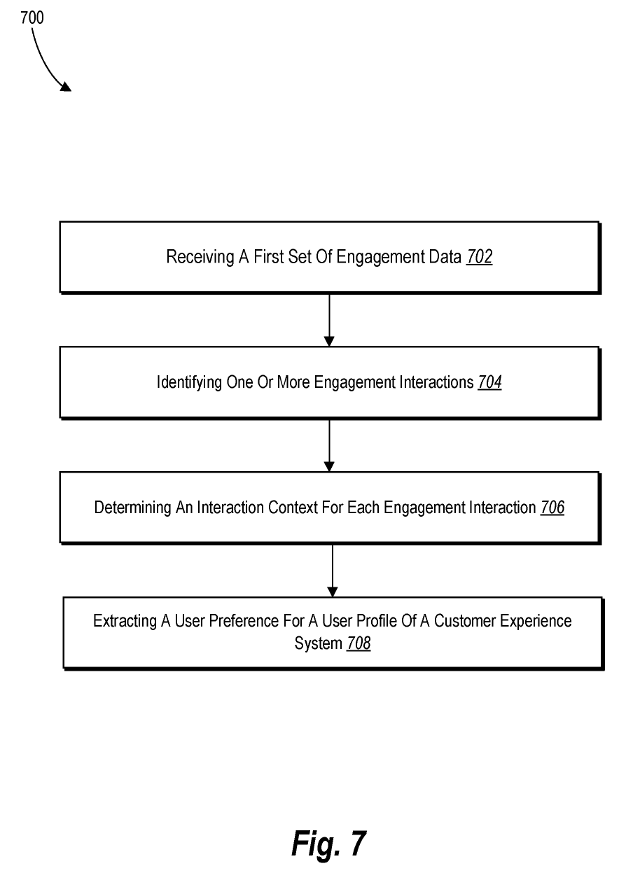

FIGS. 1–6, the corresponding text, and the examples provide a number of different methods, systems, devices, and non-transitory computer-readable media of the context determination system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for determining an interaction context for an interaction in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 include an act 702 of receiving engagement data corresponding to a user engagement event with an engagement interface, an act 704 of generating an interaction corresponding to a user profile, an act 706 of determining an interaction context for the interaction, and an act 708 of updating the user profile by extracting a user preference from the interaction context.

In particular, the act 702 can include receiving engagement data corresponding to a user engagement event with an engagement interface, the user engagement event associated with a user profile within an experience management system, the act 704 can include generating, based on the engagement data, an interaction corresponding to the user profile, the act 706 can include determining, based on the interaction, an interaction context for the interaction, and the act 708 can include updating the user profile within the experience management system by extracting a user preference from the interaction context and applying the user preference to the user profile.

For example, in one or more embodiments, the act 702 includes wherein the engagement data corresponding to the user engagement event comprises one or more of viewer data from a web page, usage data from a client application, unstructured text data from an electronic communication, or unstructured transcription text data from an audio communication.

Also, in one or more embodiments, the series of acts 700 include extracting content from the engagement data, analyzing the content to identify a topic according to a topic model, and providing a contextual prompt comprising the content and the topic to a large language model to generate the interaction. In addition, in one or more embodiments, the series of acts includes identifying, within the experience management system, enrichment data associated with the user profile and associating the enrichment data with the interaction

Additionally, in one or more embodiments, the series of acts 700 include determining, based on the interaction context, that the interaction corresponds to an initiation touchpoint for an experience journey and initiating tracking of the experience journey by associating the experience journey with the user profile based on the interaction corresponding to the initiation touchpoint. Further, in one or more embodiments, the series of acts 700 include determining, based on the interaction context, that the interaction corresponds to an intermediate touchpoint of an experience journey associated with the user profile and associating the interaction with the experience journey based on the interaction corresponding to the intermediate touchpoint. Moreover, in one or more embodiments, the series of acts 700 include determining, based on the interaction context, a next journey touchpoint for an experience journey associated with the user profile, determining a system action corresponding to the next journey touchpoint for the experience journey, and executing the system action with respect to the user profile.

In addition, in one or more embodiments, the series of acts 700 include extracting the user preference for the user profile by extracting one or more of a user interest, a user motivation, a user intent, a user want, a user need, a user demographic, or a user personalized content. Further, in one or more embodiments, the series of acts 700 include generating, from the engagement data, an additional interaction corresponding to the user profile, determining, based on the additional interaction, an additional interaction context for the interaction, and determining that the interaction corresponds to a first experience journey associated with the user profile based on the interaction context and the additional interaction corresponds to a second experience journey associated with the user profile based on the additional interaction context.

Moreover, in one or more embodiments, the series of acts 700 include receiving additional engagement data corresponding to an additional user engagement event with an engagement interface, the additional engagement data associated with the user profile, generating, based on the additional engagement data, an additional interaction corresponding to the user profile, determining, based on the additional interaction, an additional interaction context for the additional interaction, and determining, based on the interaction context and the additional interaction context, that the interaction and the additional interaction correspond to an experience journey associated with the user profile.

Further, in one or more embodiments, the series of acts 700 include receiving a first set of engagement data corresponding to a first user engagement event with a first engagement interface and a second set of engagement data corresponding to a second user engagement event with a second engagement interface, the first user engagement event and the second user engagement event associated with a user profile within an experience management system, generating, from the first set of engagement data and the second set of engagement data, one or more interactions corresponding to the user profile, determining an interaction context for each interaction of the one or more interactions, and updating the user profile within the experience management system by extracting a user preference from the interaction context for each interaction of the one or more interactions and applying the user preference to the user profile.

Also, in one or more embodiments, the series of acts 700 include wherein the first set of engagement data corresponding to the first user engagement event comprises a first engagement data type and the second set of engagement data corresponding to the second user engagement event comprise a second engagement data type. In addition, in one or more embodiments, the series of acts 700 include wherein the first engagement data type and the second engagement data type each comprise one or more of viewer data from a web page, usage data from a client application, unstructured text data from an electronic communication, or unstructured transcription text data from an audio communication.

Additionally, in one or more embodiments, the series of acts 700 include determining, based on the interaction context for each interaction of the one or more interactions, that an interaction of the one or more interactions correspond to an intermediate touchpoint of an experience journey associated with the user profile and associating the interaction of the one or more interactions to the experience journey based on the interaction corresponding to the intermediate touchpoint. Further, in one or more embodiments, the series of acts 700 include identifying an experience journey associated with the user profile, determining, based on the one or more interactions, a next journey touchpoint for the experience journey, determining a system action corresponding to the next journey touchpoint for the experience journey, and executing the system action with respect to the user profile. In addition, in one or more embodiments, the series of acts 700 include extracting the user preference for the user profile by extracting one or more of a user interest, a user motivation, a user intent, a user want, a user need, a user demographic, or a user personalized content. Further, in one or more embodiments, the series of acts 700 include extracting content from the first set of engagement data and the second set of engagement data, analyzing the content to identify a topic according to a topic model, and providing a contextual prompt comprising the content and the topic to a large language model to generate the one or more interactions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., server(s) 106, client device(s) 114a-n, and third-party server(s) 120). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

FIG. 9 illustrates an example network environment 900 of an experience management system 902 (e.g., the experience management system 104, including the context determination system 102). The network environment 900 includes an experience management system 902 and a client device 906, connected to each other by a network 904. Although FIG. 9 illustrates a particular arrangement of the client device 906, the experience management system 902, and the network 904, this disclosure contemplates any suitable arrangement of the client device 906, the experience management system 902, and the network 904. As an example, and not by way of limitation, two or more of the client device 906 and the experience management system 902 communicate directly, bypassing the network 904. As another example, two or more of the client device 906 and the experience management system 902 may be physically or logically co-located with each other in whole or in part. Moreover, although FIG. 9 illustrates a particular number of the client device 906, the experience management system 902, and the network 904, this disclosure contemplates any suitable number of client devices 906, experience management systems 902, and networks 904. As an example, and not by way of limitation, the network environment 900 may include multiple client devices 906, multiple experience management systems 902, and multiple networks 904.

This disclosure contemplates any suitable network 904. As an example, and not by way of limitation, one or more portions of the network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 904 may include one or more networks 904.

Links may connect the client device 906 and the experience management system 902 to the network 904 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by the client device 906. As an example, and not by way of limitation, a client device 906 may include any of the computing devices discussed above in relation to FIG. 8. A client device 906 may enable a network user at the client device 906 to access a network. A client device 906 may enable its user to communicate with other users at other client devices 906. A client device 906 can be the administrator client device 118. A client device 906 can be the user client device(s) 114a-114n. A client device 906 can include both the administrator client device 118 and the user client device(s) 114a-114n.

In particular embodiments, the client device 906 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as the server(s) 106), and the web browser may generate a Hyper Text Transfer Protocol (“HTTP”) request and communicate the HTTP request to the server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

The experience management system 902 may be accessed by the other components of the network environment 900 either directly or via network 904. In particular embodiments, the experience management system 902 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the experience management system 902 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 906 or the experience management system 902 to manage, retrieve, modify, add, or delete, the information stored in data storage.

In particular embodiments, the experience management system 902 may be capable of linking a variety of entities. As an example, and not by way of limitation, the experience management system 902 may enable multiple users and/or agents to interact with each other or other entities, or to allow users and/or agents to interact with these entities through an application programming interface (“API”) or other communication channels.

In particular embodiments, the experience management system 902 may include a variety of servers, sub-systems, programs, modules, logs, and data stores. In particular embodiments, the experience management system 902 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The experience management system 902 may also include suitable components such as network interfaces, security mechanisms, load balancers, failover servers, management-and-network-operations consoles, other suitable components, or any suitable combination thereof.

In particular embodiments, the experience management system 902 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., customers, etc.).

The web server may include a mail server or other messaging functionality for receiving and routing messages between the experience management system 902 and one or more client devices 906. An action logger may be used to receive communications from a web server about a user’s actions on or off the experience management system 902. In conjunction with the action log, a third-party-content-object log may be maintained of user exposures to third-party-content objects. A notification controller may provide information regarding content objects to the client device 906. Information may be pushed to the client device 906 as notifications, or information may be pulled from the client device 906 responsive to a request received from the client device 906. Authorization servers may be used to enforce one or more privacy settings of the users of the experience management system 902. A privacy setting of a user determines how particular information associated with a user can be shared. The authorization server may allow users to opt in to or opt out of having their actions logged by the experience management system 902 or shared with other systems, such as, for example, by setting appropriate privacy settings. Third-party-content-object stores may be used to store content objects received from third parties. Location stores may be used for storing location information received from the client devices 906 associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
at least one non-transitory computer-readable storage medium storing instructions that, when executed by the at least one processor, cause the system to:
receive engagement data corresponding to a user engagement event with an engagement interface, the user engagement event associated with a user profile within an experience management system;
generate, based on the engagement data, an interaction corresponding to the user profile;
determine, based on the interaction, an interaction context for the interaction; and
update the user profile within the experience management system by extracting a user preference from the interaction context and applying the user preference to the user profile.

2. The system of claim 1, wherein the engagement data corresponding to the user engagement event comprises one or more of:
viewer data from a web page;
usage data from a client application;
unstructured text data from an electronic communication;
unstructured transcription text data from an audio communication; or
unstructured transcription text data from a video communication.

3. The system of claim 1, further comprising instructions that, when executed by the at least one processor, cause the system to:
extract content from the engagement data;
extract conversation segments from the content;
analyze the conversation segments to identify a topic according to a topic model; and
provide a contextual prompt comprising the conversation segments and the topic to a large language model to generate the interaction.

4. The system of claim 1, further comprising instructions that, when executed by the at least one processor, cause the system to:
identify, within the experience management system, enrichment data associated with the user profile; and
associate the enrichment data with the interaction.

5. The system of claim 1, further comprising instructions that, when executed by the at least one processor, cause the system to:
determine, based on the interaction context, that the interaction corresponds to an initiation touchpoint for an experience journey; and
initiate tracking of the experience journey by associating the experience journey with the user profile based on the interaction corresponding to the initiation touchpoint.

6. The system of claim 1, further comprising instructions that, when executed by the at least one processor, cause the system to:
determine, based on the interaction context, that the interaction corresponds to an intermediate touchpoint of an experience journey associated with the user profile; and
associate the interaction with the experience journey based on the interaction corresponding to the intermediate touchpoint.

7. The system of claim 1, further comprising instructions that, when executed by the at least one processor, cause the system to:
determine, based on the interaction context, a next journey touchpoint for an experience journey associated with the user profile;
determine a system action corresponding to the next journey touchpoint for the experience journey; and
execute the system action with respect to the user profile.

8. The system of claim 1, further comprising instructions that, when executed by the at least one processor, cause the system to extract the user preference for the user profile by extracting one or more of a user interest, a user motivation, a user intent, a user want, a user need, a user demographic, or a user personalized content.

9. A computer-implemented method comprising:
receiving engagement data corresponding to a user engagement event with an engagement interface, the user engagement event associated with a user profile within an experience management system;
generating, based on the engagement data, an interaction corresponding to the user profile;
determining, based on the interaction, an interaction context for the interaction; and
updating the user profile within the experience management system by extracting a user preference from the interaction context and applying the user preference to the user profile.

10. The computer-implemented method of claim 9, further comprising:
determining, based on the interaction context, that the interaction corresponds to an initiation touchpoint for an experience journey; and
initiating tracking of the experience journey by associating the experience journey with the user profile based on the interaction corresponding to the initiation touchpoint.

11. The computer-implemented method of claim 9, further comprising:
determine, based on the interaction context, that the interaction corresponds to an intermediate touchpoint of an experience journey associated with the user profile; and
associating the interaction with the experience journey based on the interaction corresponding to the intermediate touchpoint.

12. The computer-implemented method of claim 9, further comprising:
generating, from the engagement data, an additional interaction corresponding to the user profile;
determining, based on the additional interaction, an additional interaction context for the interaction; and
determining that the interaction corresponds to a first experience journey associated with the user profile based on the interaction context and the additional interaction corresponds to a second experience journey associated with the user profile based on the additional interaction context.

13. The computer-implemented method of claim 9, further comprising:
receiving additional engagement data corresponding to an additional user engagement event with an engagement interface, the additional engagement data associated with the user profile;
generating, based on the additional engagement data, an additional interaction corresponding to the user profile;
determining, based on the additional interaction, an additional interaction context for the additional interaction; and
determining, based on the interaction context and the additional interaction context, that the interaction and the additional interaction correspond to an experience journey associated with the user profile.

14. A system comprising:
at least one processor; and
at least one non-transitory computer-readable storage medium storing instructions that, when executed by the at least one processor, cause the system to:
receive a first set of engagement data corresponding to a first user engagement event with a first engagement interface and a second set of engagement data corresponding to a second user engagement event with a second engagement interface, the first user engagement event and the second user engagement event associated with a user profile within an experience management system;
generate, from the first set of engagement data and the second set of engagement data, one or more interactions corresponding to the user profile;
determine an interaction context for each interaction of the one or more interactions; and
update the user profile within the experience management system by extracting a user preference from the interaction context for each interaction of the one or more interactions and applying the user preference to the user profile.

15. The system of claim 14, wherein the first set of engagement data corresponding to the first user engagement event comprises a first engagement data type and the second set of engagement data corresponding to the second user engagement event comprise a second engagement data type.

16. The system of claim 15, wherein the first engagement data type and the second engagement data type each comprise one or more of:
viewer data from a web page;
usage data from a client application;
unstructured text data from an electronic communication; or
unstructured transcription text data from an audio communication.

17. The system of claim 14, further comprising instructions that, when executed by the at least one processor, cause the system to:
determine, based on the interaction context for each interaction of the one or more interactions, that an interaction of the one or more interactions correspond to an intermediate touchpoint of an experience journey associated with the user profile; and
associate the interaction of the one or more interactions to the experience journey based on the interaction corresponding to the intermediate touchpoint.

18. The system of claim 14, further comprising instructions that, when executed by the at least one processor, cause the system to:
identify an experience journey associated with the user profile;
determine, based on the one or more interactions, a next journey touchpoint for the experience journey;
determine a system action corresponding to the next journey touchpoint for the experience journey; and
execute the system action with respect to the user profile.

19. The system of claim 14, further comprising instructions that, when executed by the at least one processor, cause the system to extract the user preference for the user profile by extracting one or more of a user interest, a user motivation, a user intent, a user want, a user need, a user demographic, or a user personalized content.

20. The system of claim 14, further comprising instructions that, when executed by the at least one processor, cause the system to:
extract content from the first set of engagement data and the second set of engagement data;
analyze the content to identify a topic according to a topic model; and
provide a contextual prompt comprising the content and the topic to a large language model to generate the one or more interactions.
